(19) United States
(12) Patent Application Publication
(10) Pub. No.: US 2016/0152511 A1
(43) Pub. Date: Jun. 2, 2016

(54) HIGH INFRARED TRANSMISSION GLASS SHEET

(71) Applicants: AGC GLASS EUROPE, Louvain-La-Neuve (BE); ASAHI GLASS CO LTD, Tokyo, Tokyo, Tokyo (JP)

(72) Inventors: Thomas LAMBRICHT, Perwez (BE); Audrey DOGIMONT, Sart-Dames-Avelines (BE)

(73) Assignees: AGC GLASS EUROPE, Louvain-La-Neuve (BE); ASAHI GLASS CO LTD, Chiyoda ku, Tokyo (JP)

(21) Appl. No.: 14/906,847

(22) PCT Filed: Jul. 18, 2014
(86) PCT No.: PCT/EP14/65488

§ 371 Date: Jan. 21, 2016

(30) Foreign Application Priority Data
Jul. 24, 2013 (EP) 13177776.5

(51) Int. Cl. C03C 4/10; G02B 6/10; G06F 3/042; C03C 3/087

(52) U.S. Cl. CPC C03C 4/10; C03C 3/087; G02B 6/102; G06F 3/0421; G06F 2203/04109

(57) ABSTRACT

The invention relates to a glass sheet with high IR transmission. More precisely, the invention relates to a glass sheet having a composition comprising in a content expressed in percentages of the total weight of the glass: 55≦SiO₂≦85% 0≦Al₂O₃≦30% 0≦B₂O₃≦20% 0≦Na₂O≦25% 0≦CaO≦20% 0≦MgO≦15% 10<K₂O≦20% 0≦BaO≦20% 0.002≦total iron (expressed in the form of Fe₂O₃)≦0.06%, said composition comprising a chromium content such as: 0.0001%≦Cr₂O₃≦0.06% expressed in a percentage of the total weight of glass. Because of its high IR transmission the glass sheet according to the invention can be advantageously used, for example, in a screen or panel or pad, wherein the glass sheet defines a touch sensitive surface. The invention also relates to the use of such a glass sheet in a device using an infrared radiation that propagates essentially inside said sheet.

### FIELD OF THE INVENTION

The present invention relates to a glass sheet with high infrared transmission.

The invention also relates to the use of such a glass sheet in a device using infrared radiation propagating essentially inside said sheet.

Because of its high infrared (IR) transmission, the glass sheet according to the invention can in fact be used advantageously in a touchscreen or touch panel or touchpad, for example, using optical technology called planar scatter detection (PSD) or frustrated total internal reflection (FTIR) (or any other technology that requires a high IR transmission) to detect the position of one or more objects (e.g. a finger or a stylus) on a surface of said sheet.

Consequently, the invention also relates to a touchscreen, a touch panel or a touchpad comprising such a glass sheet.

### Solutions of the Prior Art

PSD and FTIR technologies allow multiple detection touchscreens/panels to be obtained that are inexpensive and that can have a relatively significant touch-sensitive surface (for example, 3 to 100 inches) while also having a low thickness.

These two technologies involve:

(i) injection of infrared radiation (IR) by means of LEDs, for example, into an infrared transparent substrate from one or several edges/sides;
(ii) propagation of the infrared radiation inside said substrate (which thus acts as waveguide) by means of an optical phenomenon of total internal reflection (no radiation “exits” from the substrate);
(iii) contact of the surface of the substrate with any object (for example, a finger or stylus) causing a local disturbance by diffusion of the radiation in all directions; some of the deviated rays will thus be able to “exit” from the substrate.

In FTIR technology the deviated rays form an infrared light point on the inside surface of the substrate opposite the touch sensitive surface. These are seen by a special camera located below the device.

PSD technology itself involves two additional steps to the list of steps (i)-(iii):

(iv) analysis of the resulting IR radiation at the level of the edge of the substrate by a detector; and
(v) calculation by algorithms of the position(s) of the object(s) in contact with the surface from the radiation detected. This technology is disclosed in particular in document US 2013/021300 A1.

Basically, glass is a material of choice for touch panels because of its mechanical properties, its durability, its scratch resistance, its optical clarity and because it can be chemically or thermally strengthened.

In the case of glass panels used for PSD or FTIR technologies with a very substantial surface area and therefore with a relatively large length/width, the optical path of the injected IR radiation is long. In this case, the absorption of the IR radiation by the material of the glass thus has a significant effect on the sensitivity of the touch panel, which can then decrease undesirably in the length/width of the panel. In the case of glass panels used for PSD or FTIR technology with a smaller surface area and therefore with a shorter optical path of the injected IR radiation, the absorption of the IR radiation by the material of the glass also has an effect particularly on the energy consumption of the device into which the glass panel is integrated.

Therefore, a glass sheet that is highly transparent to infrared radiation is of great use in this context in order to guarantee an unimpaired or sufficient sensitivity over the whole of the touch sensitive surface when this surface is substantial. In particular, a glass sheet that has the lowest possible absorption coefficient at the wavelength of 1050 nm generally used in these technologies is desired.

To obtain a high infrared transmission (as well as transmission in the visible) it is known to reduce the total iron content in the glass (expressed in terms of Fe₂O₃ according to standard practice in the field) to obtain low-iron glasses. Silicate-based glasses always contain iron as this is present as an impurity in numerous raw materials used (and in particular sand). Iron exists in the structure of glass in the form of ferric irons Fe³⁺ and ferrous ions Fe²⁺. The presence of ferric ions Fe³⁺ gives the glass a slight absorption of low wavelength visible light and a higher absorption in the near ultraviolet (absorption band centred on 380 nm), while the presence of ferrous ions Fe²⁺ (sometimes expressed as oxide FeO) causes a high absorption in the near infrared (absorption band centred on 1050 nm). Thus, the increase in the total iron content (in its two forms) accentuates the absorption in the visible and the infrared. Moreover, a high concentration of ferrous ions Fe²⁺ causes a decrease in the transmission in the infrared (in particular the near infrared). However, to obtain an absorption coefficient at wavelength 1050 nm that is sufficiently low for touch sensitive applications solely by acting on the total iron content, such a significant decrease in the total iron content would be required that (i) either it would incur production costs that are much too high as a result of the need for very pure raw materials (which sometimes do not even exist in sufficiently pure state), (ii) or this would pose production problems (in particular premature wear of the furnace and/or difficulties in heating the glass in the furnace).

To further increase the transmission of the glass, it is also known to oxidise the iron present in the glass, i.e. to reduce the content of ferrous ions in favour of the content of ferric ions. The degree of oxidation of a glass is given by its redox defined as the atomic weight ratio of Fe²⁺ in relation to the total weight of the iron atoms present in the glass, Fe²⁺/total Fe.

In order to reduce the redox of the glass it is known to add an oxidising component to the batch of raw materials. However, the majority of known oxidising agents (sulphates, nitrates . . . ) do not have a sufficiently high oxidising power to obtain the IR transmission values sought for application to touch panels using FTIR or PSD technology or must be added in too high a quantity with collateral disadvantages such as cost, coloration, incompatibility with the production process etc.

### OBJECTIVES OF THE INVENTION

The objective of the invention in at least one of its embodiments is to provide a glass sheet with a high infrared transmission. In particular, an object of the invention is to provide a glass sheet with a high transmission to near infrared radiation.

The objective of the invention in at least one of its embodiments is to provide a glass sheet with a high infrared transmission that in particular is especially advantageous in a device using an infrared radiation that propagates essentially inside said sheet.

Another objective of the invention in at least one of its embodiments is to provide a glass sheet which, when used as touch sensitive surface in touchscreens, touch panels or touchpads of large dimension, does not cause any loss of sensitivity of the touch sensitive function, or if so very little.

Another objective of the invention in at least one of its embodiments is to provide a glass sheet which, when used as touch sensitive surface in touchscreens, touch panels or touchpads of more moderate dimensions, is beneficial to the energy consumption of the device.

Another objective of the invention in at least one of its embodiments is to provide a glass sheet with a high infrared transmission and with an acceptable aesthetic appearance for the chosen application.

Finally, the objective of the invention is also to provide a glass sheet with a high infrared transmission that is inexpensive to produce.

### OUTLINE OF THE INVENTION

The invention relates to a glass sheet having a composition that comprises in a content expressed in percentages of the total weight of the glass:

55≦SiO₂≦85%

0≦Al₂O₃≦30%

0≦B₂O₃≦20%

0≦Na₂O≦25%

0≦CaO≦20%

0≦MgO≦15%

10<K₂O≦20%

0≦BaO≦20%

0.002≦total iron (expressed in the form of Fe₂O₃)≦0.06%.

In accordance with a particular embodiment said composition additionally comprises a chromium content such as: 0.0001%≦Cr₂O₃≦0.06% expressed in a percentage of the total weight of glass.

Thus, the invention is based on a completely novel and inventive approach since it enables the posed technical problem to be solved. In fact the inventors have surprisingly shown that it was possible to obtain a highly IR transparent glass sheet without too negative an impact on its aesthetic appearance, its colour, by combining in a glass composition a low content of iron and of chromium, especially known as a powerful colouring agent in so-called “selective” coloured glasses, in a specific content range.

In the whole of the present text, when a range is indicated all the whole and subdomain values in the numerical range are expressly included as if explicitly stated. Likewise, in the whole of the present text, unless explicitly mentioned, the percentage content values are weight values expressed in relation to the total weight of the glass.

Other features and advantages of the invention will become clearer on reading the following description.

In the sense of the invention glass is understood to mean a material that is completely amorphous, and thus excludes any crystalline material, even partially (such as vitrocrystalline or glass ceramic materials, for example).

The glass sheet according to the invention can be a glass sheet obtained by a float, drawing or laminating process or any other known process for fabricating a glass sheet from a molten glass composition.

According to the invention different raw materials containing chromium can be used to introduce chromium into the glass composition. In particular, chromium oxides, CrO, Cr₂O₃, CrO₂ or CrO₃ are possible, and relatively pure, sources of chromium. Other substances that are rich in chromium can also be used such as chromates, chromites and any other chromium-based chemical compound. However, compounds containing chromium in its 6+ form are less preferred for reasons of safety.

The glass sheet according to the invention can have various and relatively significant dimensions. For example, it can have dimensions ranging up to 3.21 m×6 m or 3.21 m×5.50 m or 3.21 m×5.10 m or 3.21 m×4.50 m (referred to as a PLF glass sheet) or also, for example, 3.21 m×2.55 m or 3.21 m×2.25 m (referred to as a DLF glass sheet).

The glass sheet according to the invention can have a thickness in the range of between 0.05 and 25 mm. Advantageously, in the case of the application for touch panels, the glass sheet according to the invention can have a thickness varying between 0.1 and 6 mm. For reasons of weight in the case of the application for touch panels, the thickness of the glass sheet according to the invention is preferably 0.1 to 2.2 mm.

According to the invention the composition of the invention has a content of total iron such as: 0.002 total iron (expressed in the form of Fe₂O₃)≦0.06%. A content of total iron (expressed in the form of Fe₂O₃) of less than or equal to 0.06% by weight enables the IR transmission of the glass sheet to be increased further. The minimum value means that the cost of the glass will not be disadvantaged too much, since such low iron values often require costly very pure raw materials or the purification of raw materials. The composition preferably has a content of total iron (expressed in the form of Fe₂O₃) ranging from 0.002 to 0.04% by weight in relation to the total weight of the glass. Particularly preferred, the composition has a content of total iron (expressed in the form of Fe₂O₃) ranging from 0.002 to 0.02% by weight in relation to the total weight of the glass.

According to a particularly advantageous embodiment of the invention the composition has a chromium content such as: 0.0005%≦Cr₂O₃≦0.06%. Particularly preferred, the composition of the invention has a chromium content such as: 0.001%≦Cr₂O₃≦0.06%. Even more preferred, the composition of the invention has a chromium content such as: 0.002%≦Cr₂O₃≦0.06%. Such minimum values of chromium contents enable a further improved transmission in the IR to be obtained.

According to an advantageous embodiment of the invention the composition has a chromium content (expressed in the form of Cr₂O₃) such as: 0.0001%≦Cr₂O₃≦0.03% or even better such as 0.001%≦Cr₂O₃≦0.03% and preferably such as 0.002%≦Cr₂O₃≦0.03%. Such ranges of chromium contents enable a significant transmission in the IR to be obtained without too negative an impact on the aesthetic appearance of the glass sheet. Even more preferred, the composition of the invention has a chromium content such as: 0.0001%≦Cr₂O₃≦0.02% or even better such as 0.001%≦Cr₂O₃≦0.02% and preferably such as 0.002%≦Cr₂O₃≦0.02%.

According to another embodiment of the invention the composition has a content of Al₂O₃ expressed as a percentage in total weight of the glass such as: 0≦Al₂O₃≦18%.

According to another embodiment of the invention the composition has a content of SiO₂ expressed as a percentage in total weight of the glass such as: 55≦SiO₂≦78%.

According to another embodiment of the invention, which can be considered in combination with the preceding embodiment, the composition has a content of BaO expressed as a percentage in total weight of the glass such as: 0≦BaO≦5%.

According to another embodiment of the invention the composition has a content of Fe²⁺ (expressed in the form of FeO) of less than 20 ppm. The composition preferably has a content of Fe²⁺ (expressed in the form of FeO) of less than 10 ppm. Particularly preferred, the composition has a content of Fe²⁺ (expressed in the form of FeO) of less than 5 ppm.

According to the invention the glass sheet has a high IR transmission. More precisely, the glass sheet of the present invention has a high transmission of radiation in the near infrared. To quantify the high transmission of the glass in the infrared range, the absorption coefficient at the wavelength 1050 nm, which should thus be as low as possible in order to obtain a high transmission, will be used in the present description. The absorption coefficient is defined by the relation between the absorbance and the length of the optical path covered by an electromagnetic radiation in a given medium. It is expressed in m⁻¹. It is therefore independent of the thickness of the material, but depends on the wavelength of the absorbed radiation and the chemical nature of the material.

In the case of glass the absorption coefficient (μ) at a chosen wavelength λ can be calculated from a measurement in transmission (T) as well as the refractive index n of the material (thick=thickness), wherein the values of n, ρ and T are a function of the chosen wavelength λ:

$$μ = - \frac{1}{thick} \cdot ln [ \frac{- {( 1 - ρ )}^{2} + \sqrt{{( 1 - ρ )}^{4} + 4 \cdot {T}^{2} \cdot {ρ}^{2}}}{2 \cdot T \cdot {ρ}^{2}} ]$$

where ρ=(n−1)²/(n+1)².

Advantageously, the glass sheet according to the invention has an absorption coefficient at wavelength 1050 nm of less than or equal to 5 m⁻¹. Preferably, the glass sheet according to the invention has an absorption coefficient at wavelength 1050 nm of less than or equal to 3.5 m⁻¹. Particularly preferred, the glass sheet according to the invention has an absorption coefficient at wavelength 1050 nm of less than or equal to 2 m⁻¹. Even more preferred, the glass sheet according to the invention has an absorption coefficient at wavelength 1050 nm of less than or equal to 1 m⁻¹.

Advantageously, the glass sheet according to the invention has an absorption coefficient at wavelength 950 nm of less than or equal to 5 m⁻¹. Preferably, the glass sheet according to the invention has an absorption coefficient at wavelength 950 nm of less than or equal to 3.5 m⁻¹. Particularly preferred, the glass sheet according to the invention has an absorption coefficient at wavelength 950 nm of less than or equal to 2 m⁻¹. Even more preferred, the glass sheet according to the invention has an absorption coefficient at wavelength 950 nm of less than or equal to 1 m⁻¹.

Advantageously, the glass sheet according to the invention has an absorption coefficient at wavelength 850 nm of less than or equal to 5 m⁻¹. Preferably, the glass sheet according to the invention has an absorption coefficient at wavelength 850 nm of less than or equal to 3.5 m⁻¹. Particularly preferred, the glass sheet according to the invention has an absorption coefficient at wavelength 850 nm of less than or equal to 2 m⁻¹. Even more preferred, the glass sheet according to the invention has an absorption coefficient at wavelength 850 nm of less than or equal to 1 m⁻¹.

According to an embodiment of the invention, in addition to the impurities contained in particular in the raw materials, the composition of the glass sheet can comprise a small proportion of additives (such as agents aiding the melting or refining of the glass) or elements originating from the dissolution of the refractory materials forming the melting furnaces.

According to an embodiment of the invention the composition of the glass sheet can additionally comprise one or more colouring agents in a quantity adjusted as a function of the sought effect. This (these) colouring agent(s) can serve, for example, to “neutralize” the colour generated by the presence of the chromium and thus make the coloration of the glass of the invention more neutral, colourless. Alternatively, this (these) colouring agent(s) can serve to obtain a desired colour other than that generated by the presence of the chromium.

According to another advantageous embodiment of the invention that may be combined with the preceding embodiment, the glass sheet can be coated with a layer or a film that enables the colour that can be generated by the presence of chromium to be modified or neutralised (e.g. a film of coloured PVB).

The glass sheet according to the invention can advantageously be chemically or thermally toughened.

According to an embodiment of the invention the glass sheet is coated with at least one thin electrically conductive transparent layer. A thin electrically conductive transparent layer according to the invention can be, for example, a layer based on SnO₂:F, SnO₂:Sb or ITO (indium tin oxide), ZnO:Al or also ZnO:Ga.

According to another advantageous embodiment of the invention the glass sheet is coated with at least one antireflective (or antiglare) layer. This embodiment is clearly advantageous when the glass sheet of the invention is used as the front face of a screen. An antireflective layer according to the invention can be, for example, a layer based on porous silica with a low refractive index or can be formed from several layers (stack), in particular a stack of layers of dielectric material alternating layers of low and high refractive index and terminating with a layer of low refractive index.

According to another embodiment the glass sheet is coated with at least one anti-fingerprint layer in order to reduce/prevent fingerprints from showing. This embodiment is also advantageous in the case where the glass sheet of the invention is used as the front face of a touch screen. Such a layer can be combined with a thin electrically conductive transparent deposited on the opposite face. Such a layer can be combined with an antireflective layer deposited on the same face, wherein the anti-fingerprint layer is on the outside of the stack and thus covers the antireflective layer.

The glass sheet according to the invention can also be treated on at least one of its main faces, for example, using an acid or base delustering process in order to generate anti-fingerprint properties, for example, or also antiglare or anti-sparkling properties. This is also advantageous in particular in the case of the glass sheet of the invention being used as touch sensitive surface/screen.

Depending on the desired applications and/or properties, other layer(s)/other treatments can be deposited/conducted on one face and/or the other of the glass sheet according to the invention.

In addition, the invention also relates to a screen or panel or pad comprising at least one glass sheet according to the invention, wherein said glass sheet defines a touch sensitive surface. The touchscreen or panel or pad preferably uses FTIR or PSD optical technology. In particular, the glass sheet is advantageously mounted on top of a display surface.

Finally, the invention also relates to the use of a glass sheet having a composition that comprises the following in a content expressed in percentages of the total weight of glass:

55≦SiO₂≦85%

0≦Al₂O₃≦30%

0≦B₂O₃≦20%

0≦Na₂O≦25%

0≦CaO≦20%

0≦MgO≦15%

10<K₂O≦20%

0≦BaO≦20%

0.002≦total iron (expressed in the form of Fe₂O₃)≦0.06%

0.0001%≦Cr₂O₃≦0.06%

in a device using an infrared radiation that propagates essentially inside said sheet. The term radiation that propagates essentially inside the sheet is understood to mean a radiation that travels in the bulk of the glass sheet between the two main faces of the sheet.

Advantageously, according to an embodiment of the use of the invention the propagation of the infrared radiation occurs by total internal reflection. According to this embodiment the infrared radiation can be injected inside the glass sheet from one or more sides of said sheet. Side of the sheet is understood to be each of the four surfaces defined by the thickness of the sheet and substantially perpendicular to the two main faces of the sheet. Alternatively, still according to this embodiment, the infrared radiation can be injected inside the glass sheet from one or both of the main faces at a certain angle.

According to a particularly advantageous embodiment of the use of the invention the composition has a chromium content such as: 0.0005%≦Cr₂O₃≦0.06%. Particularly preferred, the composition has a chromium content such as: 0.001%≦Cr₂O₃≦0.06%. Even more preferred, the composition of the invention has a chromium content such as: 0.002%≦Cr₂O₃≦0.06%.

According to an advantageous embodiment of the use of the invention the composition has a chromium content (expressed in the form of Cr₂O₃) such as: 0.0001%≦Cr₂O₃≦0.03% or even better such as 0.001%≦Cr₂O₃≦0.03% and still more preferred such as: 0.002%≦Cr₂O₃≦0.03%. Such ranges of chromium contents enable a significant transmission in the IR to be obtained without too negative an impact on the aesthetic appearance of the glass sheet. Even more preferred, the composition of the invention has a chromium content such as: 0.0001%≦Cr₂O₃≦0.02% or even better such as 0.001%≦Cr₂O₃≦0.02% and preferably such as 0.002%≦Cr₂O₃≦0.02%.

According to another embodiment of the invention the composition has a content of Al₂O₃ expressed as a percentage in total weight of the glass such as: 0≦Al₂O₃≦18%.

According to another embodiment of the invention the composition has a content of SiO₂ expressed as a percentage in total weight of the glass such as: 55≦SiO₂≦78%.

According to another embodiment of the invention, which can be considered in combination with the two preceding embodiments, the composition has a content of BaO, expressed as a percentage in total weight of the glass, such as: 0≦BaO≦5%.

According to another embodiment of the use according to the invention the composition advantageously has a content of total iron (expressed in the form of Fe₂O₃) of 0.002 to 0.04% by weight in relation to the total weight of the glass, and preferably a content of total iron (expressed in the form of Fe₂O₃) of 0.002 to 0.02% by weight in relation to the total weight of the glass.

The following examples illustrate the invention without intention of limiting its coverage in any way.

### EXAMPLES

The raw materials were mixed in powder form and placed in a melting pot in accordance with the composition specified in the table below. Different samples (1-3) were prepared with variable quantities of chromium and the base composition remained fixed.

| Composition | Content [% by weight] |
|---|---|
| SiO₂ | 68.42 |
| MgO | 4.49 |
| K₂O | 14.94 |
| Na₂O | 0.71 |
| CaO | 9.32 |
| Al₂O₃ | 1.84 |
| Fe₂O₃ total | 0.01 |
| SO₃ | 0.27 |

The optical properties of the glass sample according to the invention in sheet form were determined and in particular the absorption coefficient at wavelengths of 1050, 950 and 850 nm was determined by a transmission measurement on a Perkin Elmer lambda 950 spectrophotometer fitted with an integrating sphere 150 mm in diameter, the sample being placed at the inlet port of the sphere for the measurement. These same measurements were also conducted on a reference (comparative) sample of the same base composition without added chromium.

The table below shows the absorption coefficients at wavelengths 1050, 950 and 850 nm obtained for the sample with chromium according to the invention and for the reference.

| | ppm of | | | |
|---|---|---|---|---|
| | chromium | Absorption | Absorption | Absorption |
| | (expressed in | coefficient | coefficient | coefficient |
| | the form of | at 1050 nm | at 950 nm | at 850 nm |
| Sample | Cr₂O₃) | (m⁻¹) | (m⁻¹) | (m⁻¹) |
| Reference | 0 | 3.9 | 3.8 | 3.6 |
| | (no addition) | | | |
| Invention | 15 | 2.5 | 2.5 | 2.8 |
| | 50 | 2.1 | 2.3 | 3.1 |
| | 100 | 1.5 | 1.8 | 2.5 |

These results show that the addition of chromium in a range of contents according to the invention enables the absorption coefficient at the wavelengths of 1050, 950 and 850 nm to be significantly decreased, and therefore in general enables the absorption of radiation in the near infrared to be reduced.

1. A glass sheet comprising, in weight percentages in relation to the total weight of the glass sheet:
55%≦SiO₂≦85%,
0%≦Al₂O₃≦30%,
0%≦B₂O₃≦20%,
0%≦Na₂O≦25%,
0%≦CaO≦20%,
0%≦MgO≦15%,
10%<K₂O≦20%,
0%≦BaO≦20%,
0.002%≦total iron as expressed in the form of Fe₂O₃≦0.06%, and
0.0001%≦Cr₂O₃≦0.06%, expressed in a percentage of the total weight of glass.

2. The glass sheet according to claim 1, wherein 0.0005%≦Cr₂O₃≦0.06%.

3. The glass sheet according to claim 2, wherein 0.001%≦Cr₂O₃≦0.06%.

4. The glass sheet according to claim 3, wherein 0.002%≦Cr₂O₃≦0.06%.

5. The glass sheet according to claim 1 having a content of total iron as expressed in the form of Fe₂O₃ of 0.002% to 0.04% by weight in relation to the total weight of the glass sheet.

6. The glass sheet according to claim 5, having a content of total iron as expressed in the form of Fe₂O₃ of 0.002% to 0.02% by weight in relation to the total weight of the glass sheet.

7. The glass sheet according to claim 1, wherein 0≦Al₂O₃≦18%.

8. The glass sheet according to claim 1, wherein 0≦BaO≦5%.

9. The glass sheet according to claim 1, having an absorption coefficient at wavelength 1050 nm of less than or equal to 5 m⁻¹.

10. The glass sheet according to claim 1, having an absorption coefficient at wavelength 1050 nm of less than or equal to 3.5 m⁻¹.

11. The glass sheet according to claim 10, having an absorption coefficient at wavelength 1050 nm of less than or equal to 2 m⁻¹.

12. A screen, a panel or a pad comprising at least one glass sheet according claim 1, wherein said glass sheet defines a touch sensitive surface.

13. The screen, the panel or the pad according claim 12, comprising FTIR or PSD optical technology.

14. A method for propagating infrared radiation, comprising:
installing a glass sheet in a device;
propagating the infrared radiation essentially inside within the glass sheet;
wherein the glass sheet comprises, in weight percentages in relation to the total weight of the glass sheet:
55%≦SiO₂≦85%,
0%≦Al₂O₃≦30%,
0%≦B₂O₃≦20%,
0%≦Na₂O≦25%,
0%≦CaO≦20%
0%≦MgO≦15%
10%<K₂O≦20%,
0%≦BaO≦20%,
0.002%≦total iron expressed in the form of Fe₂O₃≦0.06%, and
0.0001%≦Cr₂O₂≦0.06%.

15. The method according to claim 14, wherein the propagation of the infrared radiation occurs by total internal reflection.
